(19) United States
(12) Patent Application Publication
(10) Pub. No.: US 2015/0194652 A1
(43) Pub. Date: Jul. 9, 2015

(54) COATING APPARATUS

(71) Applicant: FUJI KIKAI KOGYO CO., LTD., Hiroshima (JP)

(72) Inventors: Seiji OKIHIRO, Hiroshima (JP); Hidenobu MIURA, Hiroshima (JP); Shinichi MATSUNAGA, Hiroshima (JP)

(21) Appl. No.: 14/587,235

(22) Filed: Dec. 31, 2014

(30) Foreign Application Priority Data
Jan. 7, 2014 (JP) 2014-001214

(51) Int. Cl. H01M 2/14; H01M 2/16; B05C 11/10; B05C 1/00

(52) U.S. Cl. CPC H01M 2/145; B05C 1/00; H01M 2/1653; B05C 11/10

(57) ABSTRACT

Provided is a coating apparatus that can thinly and evenly apply a coating liquid to a target surface of a separator film for lithium ion secondary batteries. Specifically, the coating apparatus includes a coating unit having a coating roll coating a target surface of a separator film fed in the vertical direction, and a pair of coating support rolls having a diameter smaller than that of first and second guide rolls, located between the first and second guide rolls, and closely and respectively located upstream and downstream of the coating roll in the film feed direction, wherein the coating support rolls push the surface of the film opposite to the target surface.

### BACKGROUND

The present disclosure relates to coating apparatuses applying a coating liquid to a target surface of a separator film for lithium ion secondary batteries.

In recent years, lithium ion secondary batteries have been utilized for automobiles, cellular phones, etc., since such batteries have a higher energy density and products including such batteries achieve a reduced size. Such lithium ion secondary batteries include a lithium ion secondary battery where a resin-made separator film is interposed between a positive electrode sheet and a negative electrode sheet to prevent a short-circuit between the positive electrode sheet and the negative electrode sheet, and a target surface of the separator film is coated with a coating liquid by using a coating apparatus to improve heat resistant properties and adhesion to the positive electrode sheet and the negative electrode sheet.

For example, Japanese Unexamined Patent Publication No. 2009-218053 discloses a coating apparatus including a recessed, upwardly-opening liquid reservoir with a container storing a coating liquid in the liquid reservoir, and a coating roll whose outer peripheral surface is partially immersed in the liquid reservoir from the upper part thereof, wherein a separator film is substantially horizontally fed above the coating roll. At both of the upstream side and the downstream side of the coating roll in the film feed direction, the continuously fed film is wound from below, and a pair of guide rolls guiding the film by rotation movement are disposed. The coating roll transfers a coating liquid, attached to its outer peripheral surface, to a target surface of the separator film while rotating in a direction reverse to the film feed direction.

### SUMMARY

These days, there has been a demand for thinly and evenly applying a coating liquid to a separator film to provide thinner and lighter lithium ion secondary batteries. In order to satisfy the demand, it is necessary to reduce a contact region where a coating roll contacts a continuously fed separator film in the film feed direction, and to reduce variation of the contact region.

However, the separator film is generally made of a thermoplastic resin and is likely to expand. Therefore, the coating apparatus as shown in Japanese Unexamined Patent Publication No. 2009-218053 is configured such that the coating roll is in contact with a region of the continuously fed separator film between the both guide rolls where tension is applied to try to eliminate the variation of the contact region. However, the region in the separator film where the tension is applied is likely to fall downward due to its own weight, and therefore, a region where the separator film is coated is less likely to be flat, and the contact region of the coating roll with the separator film significantly varies in the film feed direction and the film width direction, resulting in variation of the thickness of the coating liquid applied to the separator film.

If the separator film is coated with the coating liquid, a coating roll having spiral grooves continuously extending on the outer peripheral surface thereof is generally used. Since the continuously extending grooves move along with the rotation movement of the coating roll, a path through which the separator film is fed is likely to vary when coating is performed using the coating roll, and due to this variation, the separator film is corrugated when being fed and is less likely to be flat. In this regard, the thickness of the coating liquid applied to the separator film is likely to vary according to the location.

The present disclosure has been developed in view of the above problems, and the present disclosure provides a coating apparatus thinly and evenly applying a coating liquid to a target surface of a separator film for lithium ion secondary batteries.

In order to attain the above object, the present disclosure is characterized in that a pair of coating support rolls are closely and respectively located upstream and downstream of a coating roll in a film feed direction to improve flatness of a separator film that is continuously fed by the coating support roll in the vertical direction.

Thus, according to a first aspect of the disclosure, a coating apparatus includes: a coater including a coating roll applying a coating liquid, attached to an outer peripheral surface of the coating roll, to a target surface of a strip-shaped separator film, for a lithium ion secondary battery, made of a thermoplastic resin, and continuously fed in a vertical direction by rotation; a first guide roll located adjacent to the target surface of the film or a surface of the film opposite to the target surface, located upstream of the coating roll in a film feed direction, and configured to guide the film by rotation; a second guide roll located adjacent to the surface of the film opposite to the target surface, located downstream of the coating roll in the film feed direction, and configured to guide the film by rotation; and a pair of coating support rolls having a diameter smaller than that of the first and second guide rolls, closely located between the first and second guide rolls, respectively located upstream and downstream of the coating roll in the film feed direction, and configured to push the surface of the film opposite to the target surface.

According to a second aspect of the disclosure, in the first aspect of the disclosure, the coating apparatus further includes: a tension modifier configured to modify tension of a predetermined region of the continuously fed film; and a dryer located downstream of the second guide roll in the film feed direction, and configured to dry the coating liquid attached to the target surface of the film while the film is continuously fed, wherein the tension modifier includes a suction roll located adjacent to the surface of the film opposite to the target surface between the second guide roll and the dryer, feeding the film by rotation while sucking the film by using multiple suction holes formed on an outer peripheral surface of the suction roll, and the tension modifier modifies the tension of the region of the film such that the tension of the region before passing through the suction roll is higher than that after passing through the suction roll.

According to a third aspect of the disclosure, in the first aspect of the disclosure, the first guide roll serves as an expander roll.

According to a fourth aspect of the disclosure, in the first aspect of the disclosure, an expander roll is provided to be located upstream of the first guide roll in the film feed direction.

According to a fifth aspect of the disclosure, in the first aspect of the disclosure, the first guide roll is located adjacent to the target surface of the film such that the film is continuously fed in a S shape by the first guide roll and the coating support roll located upstream of the coating roll in the film feed direction.

According to a sixth aspect of the disclosure, in the first aspect of the disclosure, the coating support roll includes a roll inclination adjuster configured to move one end of the coating support roll in a rotation axis thereof to be adjacent to or away from the surface of the film opposite to the target surface, thereby adjusting an inclination angle of the coating support roll relative to the surface of the film opposite to the target surface.

According to a seventh aspect of the disclosure, in the first aspect of the disclosure, the coater includes: a coating chamber having a liquid reservoir storing the coating liquid and partially immersing an outer peripheral surface of the coating roll therein; a doctor blade located at one side of the coating chamber in a direction along a radial direction of the coating roll, having a tip pressing and contacting the outer peripheral surface of the coating roll, thereby scraping away an excess coating liquid attached to the outer peripheral surface in rotation movement; a sealing plate located at the other side of the coating chamber in the direction along the radial direction of the coating roll, having a tip pressing and contacting the outer peripheral surface of the coating roll, thereby sealing the liquid reservoir; and a pair of side seal located adjacent to both ends of the coating chamber in a direction along a rotation axis direction of the coating roll, having an edge pressing and contacting the outer peripheral surface of the coating roll, thereby sealing the liquid reservoir together with the doctor blade and the sealing plate, a region of the coating roll at least including the outer peripheral surface is made of a ceramic material, and the doctor blade is made of a resin material.

According to the first aspect of the disclosure, the coating liquid is applied while the separator film is vertically fed. Therefore, the separator film does not fall toward the coating roll due to its own weight and a contact region between the outer peripheral surface of the coating roll and the separator film does not vary. The both of the coating support rolls are closely and respectively located upstream and downstream of the coating roll in the film feed direction. Therefore, the length of a region of the separator film between the coating support rolls in the film feed direction is shortened, whereby the region of the separator film located therebetween is less likely to be deformed, the flatness of the film is improved, and the coating liquid as a thin film can evenly be applied.

According to the second aspect of the disclosure, the coater located upstream of the suction roll in the film feed direction is located in the region of the film where tension is higher, and therefore, coating can be performed while the film is less likely to be deformed and has higher flatness. The dryer located downstream of the suction roll in the film feed direction is located in the region of the film where tension is lower, and therefore, even if the separator film is made of a thermoplastic resin that is likely to expand due to an increase in temperature, the film is less likely to expand when passing through the dryer, thereby preventing causing defects in the product. The surface of the film opposite to the target surface is wound on the suction roll, thereby modifying the tension of the region of the film such that the tension of the region of the film before passing through the suction roll is different from that after passing through the suction roll without affecting the coating liquid, which is not dried yet, attached to the target surface of the film.

According to the third and the fourth aspects of the disclosure, the separator film expands in the film width direction immediately before passing through the coater, and therefore, tension applied in the width direction of the film is stable, thereby further being able to suppress vibration of the separator film in coating and modification of the feed path in coating.

According to the fifth aspect of the disclosure, the contact region (wrap angle) between the separator film and the coating support roll located upstream in the film feed direction and the contact region (wrap angle) between the separator film and the first guide roll are increased, and therefore, the feed path of the film before the film passes through the coater can be maintained.

According to the sixth aspect of the disclosure, the inclination of the coating support roll can be modified such that the rotation axis of the coating support roll is parallel to the target surface of the separator film. Therefore, even if maintenance, etc., is performed to modify the inclination of the coating support roll relative to the target surface of the film, the inclination of the coating support roll is further modified according to the target surface whereby pressing balance between both sides of the coating roll in the roll rotation axis relative to the separator film can be maintained even after the maintenance, etc.

According to the seventh aspect of the disclosure, when the doctor blade scrapes away the excess coating liquid attached to the outer peripheral surface of the coating roll, even if part of the outer peripheral surface of the coating roll and part of the tip of the doctor blade are peeled off due to abrasion to be mixed with the coating liquid, the material of the coating roll and the material of the doctor blade are non-conductive, and therefore, a defect of the product is less likely to occur.

### BRIEF DESCRIPTION OF THE DRAWINGS

FIG. 1 is a schematic front view of a coating apparatus according to an embodiment of the present disclosure.

FIG. 2 is an enlarged view of A part in FIG. 1.

FIG. 3 is a view seen from a direction of arrow B in FIG. 2.

FIG. 4 is a cross-sectional view taken along line C-C in FIG. 3.

### DETAILED DESCRIPTION

An embodiment of the present disclosure will be described in detail hereinafter with reference to the drawings. The following explanations of a preferred embodiment are substantially mere examples.

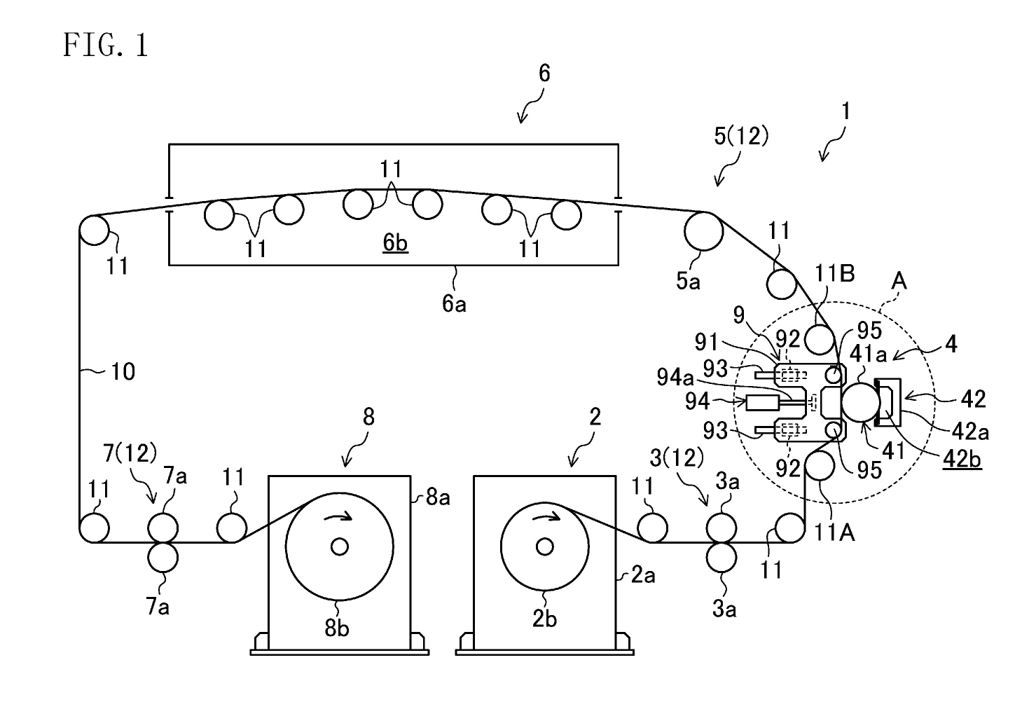

FIG. 1 illustrates a coating apparatus 1 according to the embodiment of the present disclosure. The coating apparatus 1 applies a coating liquid W to one surface (target surface) of a strip-shaped, continuously fed separator film 10 to form a protective layer having a thickness of 1-20 μm (dry). The film 10 is made of a thermoplastic resin, and is interposed between a positive electrode sheet and a negative electrode sheet of a lithium ion secondary battery. The coating liquid W is applied to the film 10, thereby improving heat resistant properties of the film 10, and adhesion to the positive electrode sheet and the negative electrode sheet.

The coating apparatus 1 includes, in sequence from the upstream side to the downstream side in a feed direction, a film feeder 2 feeding or unwinding the film 10, a first tension modifying unit 3 modifying tension of the film 10 fed from the film feeder 2 such that the tension of the region of the film 10 before passing through the first tension modifying unit 3 is different from that after passing through the first tension modifying unit 3, a coating unit 4 (coater) coating the film 10, a second tension modifying unit 5 modifying tension of the film 10 having passed through the coating unit 4 such that the tension of the region of the film 10 before passing through the second tension modifying unit 5 is different from that after passing through the second tension modifying unit 5, a dryer 6 (drying unit) drying the coated film 10, a third tension modifying unit 7 modifying tension of the film 10 having passed through the dryer 6 such that the tension of the region of the film 10 before passing through the third tension modifying unit 7 is different from that after passing through the third tension modifying unit 7, and a film rewinder 8 rewinding the film 10 on which the protective layer is formed, wherein the film 10 is wound on a plurality of guide rolls 11 to be continuously fed.

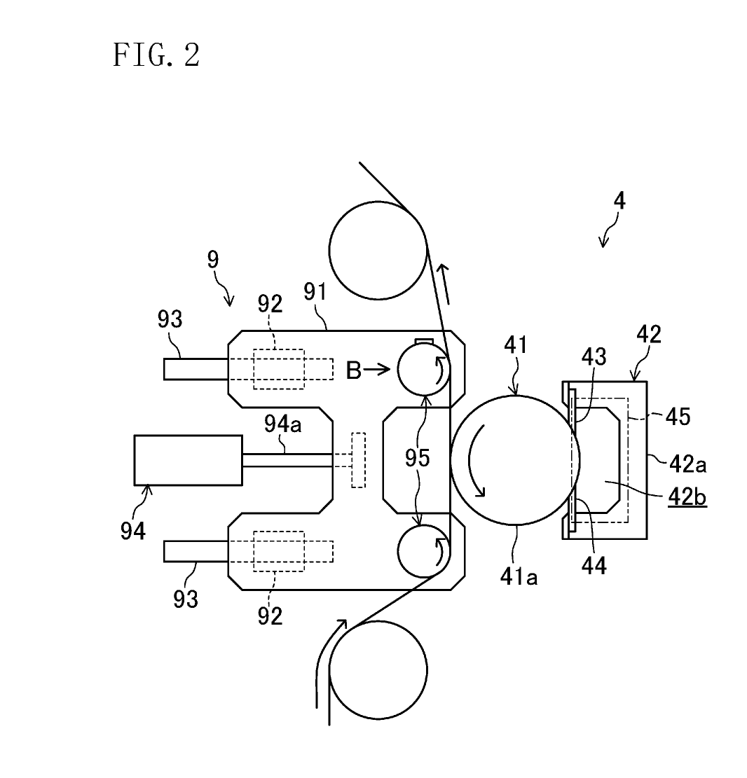

FIGS. 1 and 2 are illustrated such that each configuration of the coating apparatus 1 according to the present disclosure is easily seen, thereby making its characteristics easily understood.

The film feeder 2 includes a supporting table 2a having a substantially rectangular shape when viewed from the front, and a feed 2b rotatably supported by the supporting table 2a and formed by winding the film 10 in roll form.

The first tension modifying unit 3 includes a pair of first feed rolls 3a vertically inserting the film 10 unwound from the feed 2b and continuously fed in a substantially horizontal direction (the right side of the paper of FIG. 1). The peripheral speed of the first feed roll 3a is modified according to the feeding speed of the film 10, thereby modifying tension applied to the film 10.

The coating unit 4 includes a coating roll 41 having multiple fine recesses, which are not illustrated, on an outer peripheral surface 41a thereof, and a coating chamber 42 extending in the width direction of the film 10 and having a substantially rectangular parallelepiped shape. The coating roll 41 and the coating chamber 42 are sequentially aligned in a side adjacent to a target surface of the film 10 (the right side of FIG. 2) in the substantially horizontal direction.

The coating roll 41 has a diameter φ of 40-150 mm, and preferably has a diameter φ of 60-120 mm.

An outer peripheral layer, including the outer peripheral surface 41a, of the coating roll 41 is made of a ceramic material, and the outer peripheral surface 41a includes a plurality of, continuously-formed, spiral grooves (not shown) thereon, where the grooves are provided so as to extend from a side adjacent to one end of a rotation axis of the coating roll 41 toward the other end of the rotation axis along the rotation direction.

The coating chamber 42 includes a chamber body 42a having a substantially U-shaped cross section and opening toward the coating roll 41.

The inside of the chamber body 42a is a liquid reservoir 42b for storing the coating liquid W, and the coating roll 41 is partially immersed in the liquid reservoir 42b.

In the upper part of the coating chamber 42 (one side of the roll in the radial direction), a plate-shaped doctor blade 43 made of a resin is provided to protrude downward from the edge of the upper part of the opening of the liquid reservoir 42b, and the tip of the doctor blade 43 presses and contacts the outer peripheral surface 41a of the coating roll 41 to seal the upper part of the liquid reservoir 42b, and scrape away the excess coating liquid W attached to the outer peripheral surface 41a in the rotation movement of the coating roll 41.

In the lower part of the coating chamber 42 (the other side of the roll in the radial direction), a sealing plate 44 made of a resin is located to protrude upward from the edge of the lower part of the opening of the liquid reservoir 42b, and the tip of the sealing plate 44 presses and contacts the outer peripheral surface 41a of the coating roll 41 to seal the lower part of the liquid reservoir 42b.

Furthermore, a pair of side seals 45 made of a resin are located at both sides of the coating chamber 42 in a direction along a rotation axis of the coating roll 41, and the doctor blade 43, the sealing plate 44, and the side seals 45 seal the liquid reservoir 42b.

While rotating the coating roll 41, the coating unit 4 allows the outer peripheral surface 41a to contact the target surface of the film 10 whose feed direction having been modified after having passed through the first tension modifying unit 3 such that the film 10 is fed upward, thereby transferring the coating liquid W to the film 10.

The guide roll 11 (hereinafter referred to as a “first guide roll 11A”) adjacent to the upstream side of the coating roll 41 in the film feed direction is located adjacent to the target surface of the film 10 and configured to guide the continuously fed film 10 by rotation movement.

The first guide roll 11A has a uniform cross-section in a rotation axis direction thereof, and serves as an expander roll in which a cross-sectional central portion at each of both ends in the rotation axis direction thereof is consistent with a rotation axis thereof, and in which a cross-sectional central portion at the center in the rotation axis direction thereof is radially outwardly eccentric from the rotation axis thereof.

The guide roll 11 (hereinafter referred to as “second guide roll 11B”) adjacent to the downstream side of the coating roll 41 in the film feed direction is located adjacent to the surface of the film 10 opposite to the target surface and configured to guide the continuously fed film 10 by rotation movement.

A coating support mechanism 9 is provided between the first and second guide rolls 11A, 11B and located adjacent to the surface of the film 10 opposite to the target surface (the left side of the paper of FIG. 2) to face the coating roll 41.

The coating support mechanism 9 includes a pair of base plates 91 facing each other at a predetermined interval in a direction along the rotation axis direction of the coating roll 41, and the pair of the base plates 91 have a substantially H shape when viewed from the front.

The base plates 91 are provided between a pair of frames which are fixed portions of the coating unit 4 and not illustrated, and a pair of sliders 92 are vertically provided to face the frames at a predetermined interval.

On a surface of the frames, which are fixed portions of the coating unit 4 and not illustrated, facing the respective base plates 91, a pair of slide rails 93 extending in a horizontal direction crossing the rotation axis direction of the coating roll 41 are provided in the associated positions of the sliders 92 such that each of the sliders 92 slidably fits with the outer periphery of the corresponding slide rail 93.

A fluid-pressure cylinder 94 is provided at a side of the base plate 91 away from the coating unit 41, and includes a piston rod 94a having an end connected to the base plate 91 and expanding and contracting in the horizontal direction crossing the rotation axis direction of the coating roll 41.

If the piston rod 94a of the fluid-pressure cylinder 94 is expanded and contracted, the sliders 92 slide on the respective slide rails 93, whereby the base plates 91 move in the horizontal direction.

In a side between the base plates 91 and closer to the coating roll 41, a pair of coating support rolls 95 made of carbon are vertically provided at a predetermined interval such that the rotation axis of each of the support rolls 95 has the same direction as the rotation axis of the coating roll 41. The distance between coating support rolls 95 is set to 0-100 mm.

Each of the coating support rolls 95 has a diameter φ of 40 mm smaller than that of the first and second guide rolls 11A, 11B. When the fluid-pressure cylinder 94 causes both of the base plates 91 to move toward the coating roll 41, the coating support rolls 95 are closely located between the first and second guide rolls 11A, 11B, and are respectively located upstream and downstream of the coating roll 41 in the film feed direction. The coating support rolls 95 press the surface opposite to the target surface of the film 10 to eliminate deformation of the film 10 to improve flatness of the film 10. In the embodiment of the present disclosure, each of the coating support rolls 95 has a diameter φ of 40 mm. The coating support roll 95 may have a diameter φ 20-80 mm.

The first guide roll 11A is adjacent to the target surface of the film 10 while both of the base plates 91 are located adjacent to the coating roll 41 so as to continuously feed the film 10 in an S shape together with the coating support roll 95 located upstream of the coating roll 41 in the film feed direction.

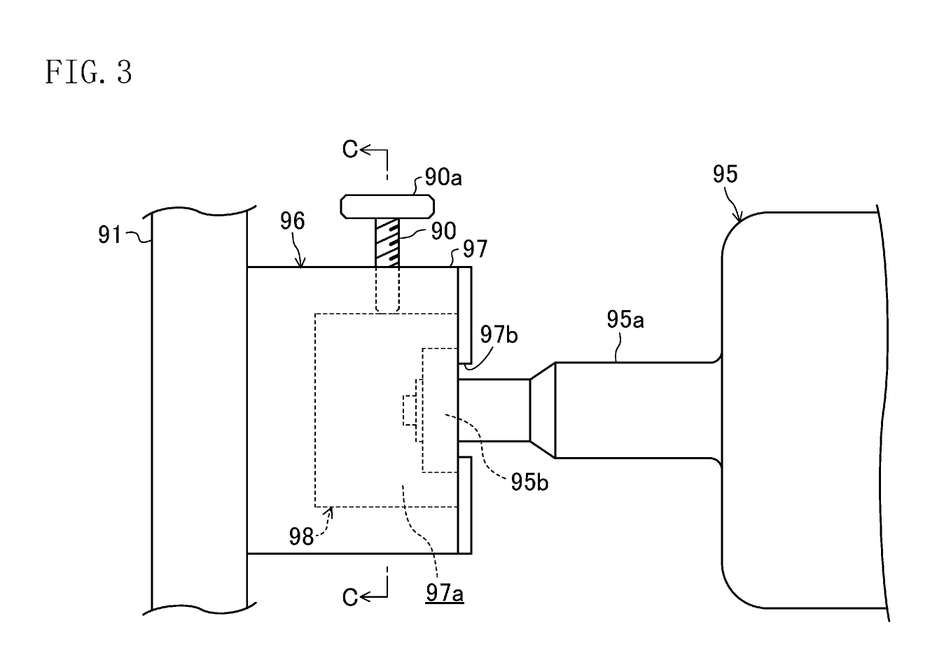

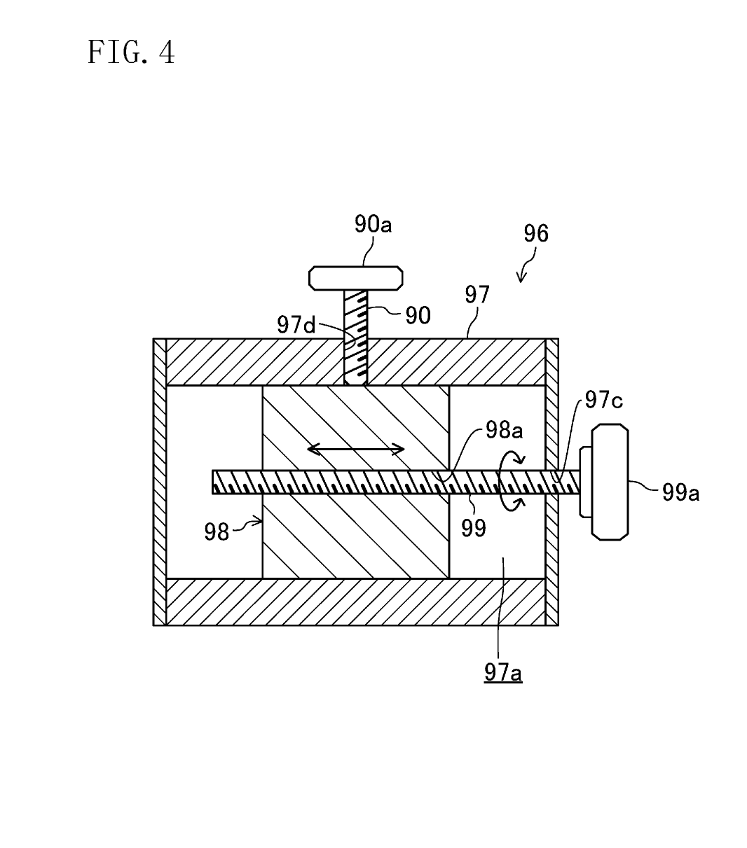

At both ends of the upper coating support roll 95 in the rotation axis direction thereof, as illustrated in FIGS. 3 and 4, a pair of roll inclination adjustment mechanisms 96 (roll inclination adjuster) are provided so as to be fixed to the base plates 91 and rotatably axially support rotation shafts 95a of the coating support roll 95.

Each of the roll inclination adjustment mechanisms 96 includes a rectangular parallelepiped case 97 having an inner space 97a, and in a side of the case 97 adjacent to the coating support roll 95, an opening 97b is formed so as to extend in a horizontal direction crossing the rotation axis of the coating support roll 95.

In the middle portion of the inner space 97a, a block body 98 is provided to divide the inner space 97a into two parts in the horizontal direction crossing the rotation axis of the coating support roll 95. A self-aligning ball bearing 95b attached to the end of the rotation shaft 95a is connected to the block body 98 through the opening 97b.

At the center of the side wall of the case 97 adjacent to the coating roll 41, a through hole 97c is formed to pass therethrough, and a thread hole 98a in which external threads are threaded is formed in the block body 98 to pass through a location corresponding to the through hole 97c.

A first shaft 99 having an outer peripheral surface in which external threads are threaded is fitted into the thread hole 98a, and one end of the first shaft 99 is inserted into the through hole 97c.

A substantially disk-shaped handle knob 99a is attached to one end of the first shaft 99, and rotation of the handle knob 99a causes threaded advancement or retraction of the block body 98 in the horizontal direction crossing the rotation axis of the coating support roll 95. The threaded advancement or refraction of the block body 98 causes one end of the coating support roll 95 in the rotation axis thereof to be adjacent to or away from the surface of the film 10 opposite to the target surface, thereby adjusting an inclination angle of the coating support roll 95 relative to the surface of the film 10 opposite to the target surface.

At the upper surface of the case 97, a thread hole 97d in which external threads are threaded is formed to vertically pass therethrough, and a second shaft 90 having an outer peripheral surface in which external threads are threaded is fitted into the thread hole 97d.

A substantially disk-shaped handle knob 90a is attached to the upper end of the second shaft 90. When rotation of the handle knob 90a causes the lower end of the second shaft 90 to contact the upper surface of the block body 98, the movement of the block body 98 in the inner space 97a is prevented, and when rotation of the handle knob 90a causes the lower end of the second shaft 90 to be apart from the upper surface of the block body 98, the block body 98 can move in the inner space 97a.

The second tension modifying unit 5 includes a suction roll 5a having an outer peripheral surface in which multiple suction holes are formed.

The surface of the film 10 opposite to the target surface is mounted on the suction roll 5a. The suction roll 5a feeds the film 10 by rotation movement while allowing the multiple suction holes formed on the outer peripheral surface thereof to suck the film 10, thereby modifying the tension of the film 10 such that the tension of the region of the film 10 before passing through the suction roll 5a is different from that after passing through the suction roll 5a.

The dryer 6 includes a horizontally-extending body 6a having a drying space 6b therein. The body 6a includes a heater, which is not illustrated, increasing the temperature of the atmospheric gas in the drying space 6b. The coating liquid W attached to the film 10 is dried by the atmospheric gas heated by the heater when passing through the drying space 6b.

The third tension modifying unit 7 includes a pair of second feed rolls 7a vertically inserting the film 10 having passed through the dryer 6, turned by two guide rolls 11, and continuously fed in a substantially horizontal direction (the right side of the paper of FIG. 1). The peripheral speed of the second feed roll 7a is modified according to the feeding speed of the film 10, thereby modifying the tension applied to the film 10 such that the tension of the region of the film 10 before passing through the second feed roll 7a is different from that after passing through the second feed roll 7a.

The first tension modifying unit 3, the second tension modifying unit 5, and the third tension modifying unit 7 constitute a tension modifier 12 in the present disclosure.

The tension modifier 12 modifies a tension of a predetermined region in the continuously fed film 10. Thus, the peripheral speeds of the first feed rolls 3a, the suction roll 5a, and the second feed rolls 7a are modified according to the feeding speed of the film 10, thereby making it possible to modify the tension of the region in the film 10 between the first tension modifying unit 3 and the second tension modifying unit 5, and the tension of the region in the film 10 between the second tension modifying unit 5 and the third tension modifying unit 7. In the embodiment, the tension of the film 10 is modified such that the tension of the region in the film 10 between the first tension modifying unit 3 and the second tension modifying unit 5 (the region through which the suction roll 5a is about to pass) is higher than that of the region in the film 10 between the second tension modifying unit 5 and the third tension modifying unit 7 (the region through which the suction roll 5a has passed).

The film rewinder 8 includes a supporting table 8a having a substantially rectangular shape when viewed from the front, and a rewind roll 8b rotatably supported by the supporting table 8a and formed by rewinding the film 10 in roll form.

Subsequently, coating the film 10 with the coating liquid W by the coating apparatus 1 will be described.

First, the film 10 unwound from the film feeder 2 moves in the substantially horizontal direction (the right side of the paper of FIG. 1) to pass through the first tension modifying unit 3. The tension of the film 10 is modified by the pair of the first feed rolls 3a such that the tension of the region of the film 10 before passing through the first feed rolls 3a is different from that after passing through the first feed rolls 3a.

Next, the film 10 having passed through the first tension modifying unit 3 is turned by the guide roll 11 to be fed upward, and then, carried in the coating unit 4.

The film 10 is fed in a S shape by the first guide roll 11A and the coating support roll 95 while tension is applied to the film 10 in the width direction by the first guide roll 11A, and then, the film 10 is fed straight upward and the coating liquid W attached to the outer peripheral surface of the coating roll 41 rotating in the direction opposite to the feed direction is transferred to the film 10.

Subsequently, after the second guide roll 11B modifies the feed direction of the film 10 such that the film 10 is fed obliquely upward, the suction roll 5a modifies the feed direction of the film 10 such that the film 10 is substantially horizontally fed, and modifies the tension of the film 10 such that the tension of the region of the film 10 before passing through the suction roll 5a is different from that after passing through the suction roll 5a.

Then, the film 10 passes through the drying space 6b of the dryer 6, thereby drying the coating liquid W transferred to the target surface of the film 10, and then, the film 10 is turned by the two guide rolls 11 to be continuously fed in the horizontal direction (the right side of the paper of FIG. 1) and passes through the third tension modifying unit 7. The pair of the second feed rolls 7a modify the tension of the film 10 such that the tension of the region of the film 10 before passing through the second feed rolls 7a is different from that after passing through the second feed rolls 7a. Then, the film 10 is rewound by the film rewinder 8 in roll form as the rewind roll 8b.

As stated above, according to the embodiment of the present disclosure, since the coating liquid W is applied while the film 10 is vertically fed, the film 10 does not fall toward the coating roll 41 due to its own weight, thereby not causing variation of the contact region between the outer peripheral surface 41a of the coating roll 41 and the film 10. The coating support rolls 95 pressing the film 10 from the side opposite to the target surface are closely and respectively located upstream and downstream of the coating roll 41. Therefore, the length of a region of the film 10 between the coating support rolls 95 in the film feed direction is shortened, whereby the region in the film 10 located therebetween is less likely to be deformed, the flatness of the film 10 is improved, and the coating liquid W as a thin film can evenly be applied.

The coating unit 4 located upstream of the suction roll 5a in the film feed direction is located in the region of the film 10 where tension is higher, and therefore, coating can be performed while the film 10 is less likely to be deformed and has higher flatness. The dryer 6 located downstream of the suction roll 5a in the film feed direction is located in the region of the film 10 where tension is lower, and therefore, even if the separator film 10 is made of a thermoplastic resin that is likely to expand due to an increase in temperature, the film 10 is less likely to expand when passing through the dryer 6, thereby preventing causing defects in the product. The surface of the film 10 opposite to the target surface is wound on the suction roll 5a, thereby modifying the tension of the region of the film 10 such that the tension of the region of the film 10 before passing through the suction roll 5a is different from that after passing through the suction roll 5a. without affecting the coating liquid W, which is not dried yet, attached to the target surface of the film 10.

The film 10 expands in the film width direction immediately before passing through the coating unit 4, and therefore, tension applied in the width direction of the film 10 is stable, thereby further suppressing vibration of the film 10 in coating and modification of the feed path in coating.

The film 10 is fed in a S shape by the first guide roll 11A and the coating support roll 95, thereby causing an increase in the contact region (wrap angle) between the film 10 and the coating support roll 95 and the contact region (wrap angle) between the film 10 and the first guide roll 11A. Therefore, the feed path of the film 10 immediately before the film 10 passes through the coating unit 4 can be maintained.

The inclination of the coating support roll 95 can be modified such that the rotation axis of the coating support roll 95 is parallel to the target surface of the film 10. Therefore, even if maintenance, etc., is performed to modify the inclination of the coating support roll 95 relative to the target surface of the film 10, the inclination of the coating support roll 95 is further modified according to the target surface, whereby pressing balance between both sides of the coating roll 41 in the roll rotation axis relative to the film 10 can be maintained even after the maintenance, etc.

The doctor blade 43 is made of a resin material, and a region of the coating roll 41 including the outer peripheral surface 41a is made of a ceramic material. Therefore, when the doctor blade 43 scrapes away the excess coating liquid W attached to the outer peripheral surface 41a of the coating roll 41, even if part of the outer peripheral surface 41a of the coating roll 41 and part of the tip of the doctor blade 43 are peeled off due to abrasion to be mixed with the coating liquid W, the material of the coating roll 41 and the material of the doctor blade 43 are non-conductive, and therefore, a defect of the product is less likely to occur.

In the embodiment of the present disclosure, the first guide roll 11A serves as expander roll. However, the present disclosure is not limited to this example. Alternatively, a guide roll 11, adjacent to the first guide roll 11A, located upstream of the first guide roll 11A in the film feed direction may serve as an expander roll since the film 10 is expanded in the film width direction immediately before passing through the coating unit 4, and tension applied in the film width direction of the film 10 is stable to be able to suppress vibration of the film 10 in coating and modification of the feed path in coating.

In each of the first guide roll 11A serving as the expander roll or the guide roll 11, a cross-sectional central portion at both ends thereof in the rotation axis direction thereof is consistent with the rotation axis thereof, and a cross-sectional central portion at the center in the rotation axis direction thereof is radially outwardly eccentric from the rotation axis thereof. However, the present disclosure is not limited to this example. Alternatively, for example, the diameter of the cross-sectional central portion at the center in the rotation axis direction thereof may be smaller than that of the cross-sectional central portion at each of both ends thereof in the rotation axis direction thereof.

In the embodiment of the present disclosure, the outer peripheral layer of the coating roll 41 including the outer peripheral surface 41a is made of a ceramic material. However, the present disclosure is not limited thereto. Alternatively, the entire coating roll 41 may be made of a ceramic material.

In the embodiment of the present disclosure, the first guide roll 11A is located adjacent to the target surface. However, the present disclosure is not limited to the configuration. Alternatively, the first guide roll 11A may be located adjacent to the surface opposite to the target surface.

In the embodiment of the present disclosure, the coating unit 4 applies the coating liquid W to the target surface of a region where the film 10 is fed upward. However, the present disclosure is not limited to the configuration. Alternatively, the coating unit 4 may apply the coating liquid W to the target surface of the film 10 in a region where the film 10 is fed downward.

The present disclosure is suitable for a coating apparatus applying a coating liquid to a separator film for lithium ion secondary batteries.

What is claimed is:

1. A coating apparatus, comprising:
a coater including a coating roll applying a coating liquid, attached to an outer peripheral surface of the coating roll, to a target surface of a strip-shaped separator film, for a lithium ion secondary battery, made of a thermoplastic resin, and continuously fed in a vertical direction by rotation;
a first guide roll located adjacent to the target surface of the film or a surface of the film opposite to the target surface, located upstream of the coating roll in a film feed direction, and configured to guide the film by rotation;
a second guide roll located adjacent to the surface of the film opposite to the target surface, located downstream of the coating roll in the film feed direction, and configured to guide the film by rotation; and
a pair of coating support rolls having a diameter smaller than that of the first and second guide rolls, closely located between the first and second guide rolls, respectively located upstream and downstream of the coating roll in the film feed direction, and configured to push the surface of the film opposite to the target surface.

2. The coating apparatus of claim 1, further comprising:
a tension modifier configured to modify tension of a predetermined region of the continuously fed film; and
a dryer located downstream of the second guide roll in the film feed direction, and configured to dry the coating liquid attached to the target surface of the film while the film is continuously fed, wherein
the tension modifier includes a suction roll located adjacent to the surface of the film opposite to the target surface between the second guide roll and the dryer, feeding the film by rotation while sucking the film by using multiple suction holes formed on an outer peripheral surface of the suction roll, and the tension modifier modifies the tension of the region of the film such that the tension of the region before passing through the suction roll is higher than that after passing through the suction roll.

3. The coating apparatus of claim 1, wherein
the first guide roll serves as an expander roll.

4. The coating apparatus of claim 1, wherein
an expander roll is provided to be located upstream of the first guide roll in the film feed direction.

5. The coating apparatus of claim 1, wherein
the first guide roll is located adjacent to the target surface of the film such that the film is continuously fed in a S shape by the first guide roll and the coating support roll located upstream of the coating roll in the film feed direction.

6. The coating apparatus of claim 1, wherein
the coating support roll includes a roll inclination adjuster configured to move one end of the coating support roll in a rotation axis thereof to be adjacent to or away from the surface of the film opposite to the target surface, thereby adjusting an inclination angle of the coating support roll relative to the surface of the film opposite to the target surface.

7. The coating apparatus of claim 1, wherein
the coater includes:
a coating chamber having a liquid reservoir storing the coating liquid and partially immersing an outer peripheral surface of the coating roll therein;
a doctor blade located at one side of the coating chamber in a direction along a radial direction of the coating roll, having a tip pressing and contacting the outer peripheral surface of the coating roll, thereby scraping away an excess coating liquid attached to the outer peripheral surface in rotation movement;
a sealing plate located at the other side of the coating chamber in the direction along the radial direction of the coating roll, having a tip pressing and contacting the outer peripheral surface of the coating roll, thereby sealing the liquid reservoir; and
a pair of side seal located adjacent to both ends of the coating chamber in a direction along a rotation axis direction of the coating roll, having an edge pressing and contacting the outer peripheral surface of the coating roll, thereby sealing the liquid reservoir together with the doctor blade and the sealing plate, a region of the coating roll at least including the outer peripheral surface is made of a ceramic material, and
the doctor blade is made of a resin material.
